(19) United States
(12) Patent Application Publication
(10) Pub. No.: US 2006/0221536 A1
(43) Pub. Date: Oct. 5, 2006

(54) Air cleaning method and air cleaning apparatus for storage medium drives

(75) Inventor: Tsutomu Goto, Tendo (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/384,851

(22) Filed: Mar. 20, 2006

(30) Foreign Application Priority Data
Mar. 30, 2005 (JP) 2005-097805

(51) Int. Cl. H01T 23/00; H05F 3/00

(52) U.S. Cl. 361/231

(57) ABSTRACT

An air cleaning method for a storage medium drive begins by inserting, into an air inflow port provided in a housing of the drive, an air inflow nozzle which is internally provided with an ionizing electrode to generate corona discharge, charging dust particles within the apparatus by applying a voltage to the ionizing electrode. An air exhaust nozzle is inserted in an air exhaust port provided in the housing of the drive. The exhaust nozzle is internally provided with a dust collecting electrode to collect the ionized dust particles. The dust collecting electrode attracts the dust particles to the air exhaust nozzle, and the dust particles are exhausted to the external side of the drive with the air exhaust nozzle. The air inflow and air exhaust ports are then sealed.

### FIELD OF THE INVENTION

The present invention relates to an air cleaning method and an air cleaning apparatus for storage medium drives and more particularly, to air cleaning methods and apparatus for removing dust from inside a storage device such as a hard disc drive (HDD).

### BACKGROUND OF THE INVENTION

A conventional storage medium drive such as an HDD has at least one internal magnetic disk for recording data, and a head actuator for supporting a head slider to mount a recording/reproducing head. The contact start stop (CSS) system has generally been employed to park the head actuator and head slider when not in use, but recently an unloading system for drawing back the head in separation from the medium, namely the lump loading system, is in wide use. When the head actuator swings outwardly in the direction away from the center of the magnetic disk, toward the external side of the magnetic disk, the head actuator reaches a pause position. At the pause position, the end part of the head actuator is received and lifted by a lump member, which parks the head slider. On the other hand, when the head actuator swings toward the center of the magnetic disk, the end part of the head actuator is isolated from the lump member, and the head actuator floats over the disk as the disk rotates.

In recent years, the floating height of the head slider over the disk, namely, an isolation distance between the head slider and the magnetic disk medium, is usually 10 nm or less in such an HDD. Accordingly, such an HDD has a risk of fault because when dust particles of even nano-order (10-500 nm) size are generated within the hermetically sealed disk enclosure (DE) of the HDD, dust particles can get caught between the head slider and the magnetic disk, sometimes crashing the head. Therefore, cleaning of each component within the DE is thorough, and entry of dust into the DE has been greatly reduced by assembling the HDD in a clean room. However, the ability to remove small dust particles has been limited even though cleaning performance at the component level has been enhanced, and cleaning performance of the clean room has been improved. Namely, the dust particle size which can be controlled is limited to the size of about 0.5 μm, and it has been impossible to completely eliminate all dust particles.

Accordingly, dust particles can still get caught between the head slider and magnetic disk medium and thereby a read/write head element of the head slider can be damaged, resulting in deterioration in the performance of the head element. Moreover, a fault disabling read or write operation can be generated because the floating height increases when the dust particles are caught. Moreover, in the worst case, the magnetic disk medium is damaged and thereby a major fault including destruction of data has been generated in some cases.

Japanese Unexamined Patent Publication No. 04-291083 discloses an air cleaning apparatus that is integrated in the magnetic disk apparatus to collect dust particles under particular conditions. However, this structure limits potential reduction in size of the magnetic disk device, and requires control of dust collection timing, resulting in an increase in cost. Moreover, the air cleaning apparatus of the air circulating system as disclosed in the above patent publication is capable of collecting dust particles by simply absorbing dust particles with a filter through circulation of air. In this case, however, it has not sufficiently eliminated fine dust particles.

The present invention has been proposed considering the problems explained above. Therefore, an object of the present invention is to provide an air cleaning method and an air cleaning apparatus for a storage medium drive for effectively removing fine dust particles, particularly those of the nano-order size, in the storage medium drive in order to better purify the air in the storage medium drive.

### SUMMARY OF THE INVENTION

In view of achieving the object explained above, the air cleaning method for a storage medium drive according to the present invention includes the steps of temporarily providing at an air inflow port in a housing of the storage medium drive, an air inflow nozzle with an ionization electrode for ionizing dust particles within the storage medium drive. An air exhaust port is also provided in the housing of the storage medium drive. An air exhaust nozzle fits in the air exhaust port, and a dust collecting electrode collects the ionized dust particles within the storage medium drive. The air can be exhausted from the storage medium drive by one or more fans.

The dust particles are charged within the storage medium drive by applying a voltage to the ionizing electrode and the dust collecting electrode, attracting the dust particles to the dust collecting electrode, and exhausting the collected dust particles to the external side of the storage medium drive using the air exhaust nozzle. The air inflow nozzle and the air exhaust nozzle are removed after completion of dust collection.

The air cleaning apparatus includes at least the ionizing electrode for ionizing dust particles within the storage medium drive, the air inflow nozzle internally provided with the ionizing electrode for taking air into the storage medium drive, the dust collecting electrode for collecting the charged dust particles within the storage medium drive, and the air exhaust nozzle internally provided with the dust collecting electrode for exhausting the air to the external side of the storage medium drive.

In another aspect of the present invention, the air (gas) is oxygen gas.

### BRIEF DESCRIPTION OF THE DRAWINGS

FIG. 1 is a perspective view illustrating an external structure of a storage medium drive for use with an embodiment of the present invention.

FIG. 2 is a plan view of the internal structure of the storage medium drive of FIG. 1.

FIG. 3 is a diagram schematically illustrating the internal structure of an air cleaning apparatus of an embodiment of the present invention.

FIGS. 4(a) and 4(b) are diagrams illustrating needle type ionizing electrode holding members for use in the present invention.

### DESCRIPTION OF THE PREFERRED EMBODIMENTS

One embodiment of the present invention will be explained with reference to the accompanying drawings.

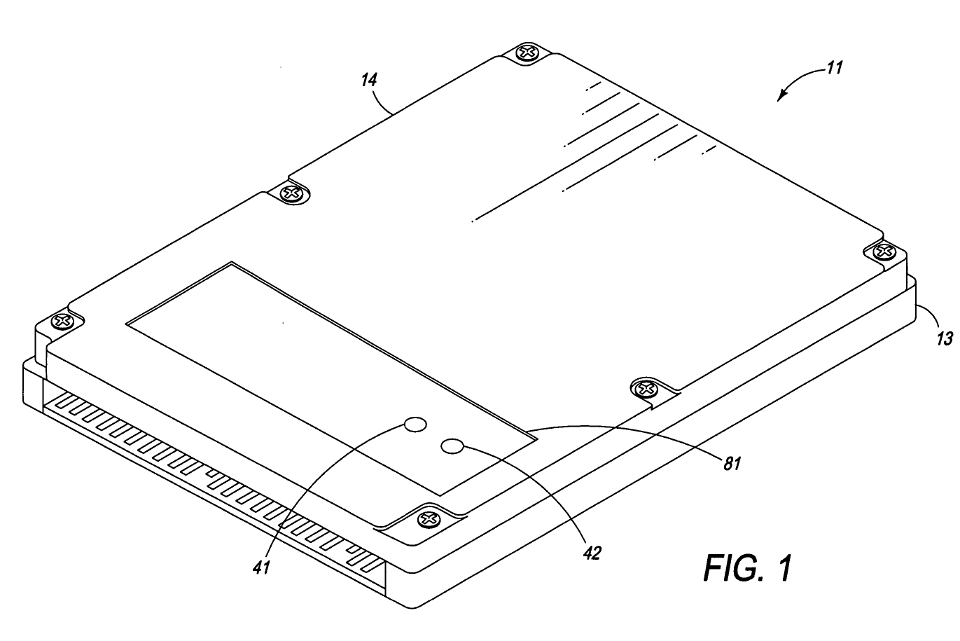

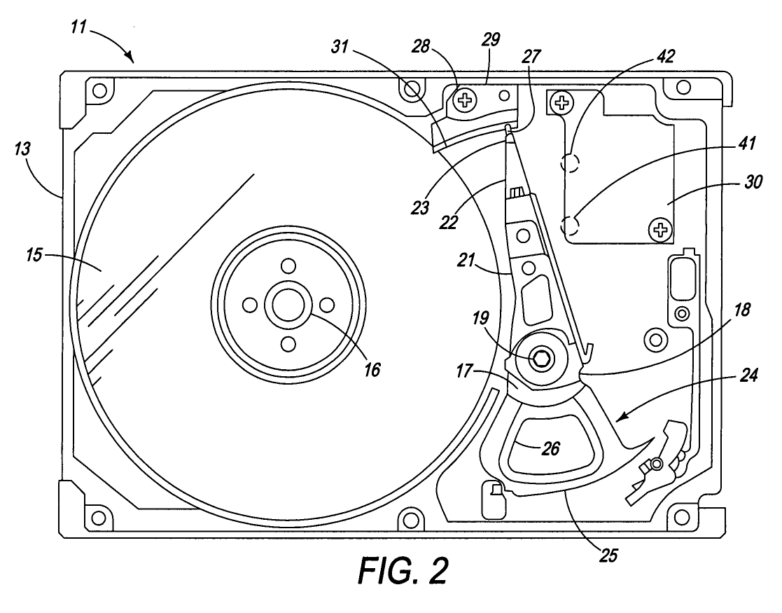

FIG. 1 is a diagram of the external structure of an exemplary storage medium drive for the present invention, namely an external structure of a hard disk drive (HDD) 11. FIG. 2 illustrates an internal structure of the storage medium drive used with the present invention, namely, an internal structure of the hard disk drive (HDD) 11. This HDD 11 is provided with a box type cabinet, namely a housing. The housing is provided with a box type base 13 for defining, for example, a flat rectangular parallelepiped accommodation space. The base 13 may be molded, for example, by casting from a metallic material such as aluminum.

The base 13 is coupled with a cover 14. The cover may be molded, for example, from a sheet of plate material on the basis, for example, of press processing. As the plate material, a metal plate such as stainless steel, for example, may be used. The plate material may be formed of a laminated layer material. Openings which would otherwise communicate with the outside atmosphere, such as a gap between the cover 14 and base 13 and screw holes, are hermetically sealed to form the DE (disk enclosure).

The accommodation space can accommodate one or more sheets of magnetic disk media 15 as the recording media. The magnetic disk 15 is fixed on the rotating shaft of a spindle motor 16. The spindle motor 16 is capable of rotating the magnetic disk media 15 at typical speeds of 5400 rpm, 7200 rpm, 10000 rpm, and 15000 rpm.

The accommodation space can further accommodate a head actuator 17. The head actuator 17 is provided with an actuator block 18. The actuator block 18 is coupled to a pivot 19 extending in the vertical direction, to allow the actuator block 18 to freely rotate. In the actuator block 18, a plurality of actuator arms 21 extending in the horizontal direction from the pivot 19 are defined. It is enough for the actuator block 18 to be molded from aluminum, for example, by extrusion molding.

At the end part of individual actuator arm 21, a head suspension 22 extending forward from the actuator arm 21 is mounted. At the end part of the head suspension 22, a so-called gimbal (not illustrated) is connected. A floating head slider 23 is fixed to the surface of a gimbal spring. The head slider 23, which can float by operation of the gimbal spring, is capable of changing its attitude for the head suspension 22.

A so-called magnetic head, namely an electro-magnetic conversion element (not illustrated) is mounted on the floating head slider 23. This electromagnetic conversion element is formed, for example, with a write element such as a thin film magnetic head for writing information to the magnetic disk medium 15, by utilizing the magnetic field formed by a thin film coil pattern. The conversion element also has a read element such as a Giant Magneto Resistive effect (GMR) element for reading the information from the magnetic disk medium 15, by sensing changes in resistance of a spin valve film, a tunnel junction film or a Tunnel Magneto Resistive effect (TMR) element.

When air flows on the surface of the magnetic disk medium 15 because of rotation thereof, a positive pressure, namely a floating force, and a negative pressure are applied to the floating head slider 23 due to the flow of air. When the floating force and negative pressure are balanced with a pressing force of the head suspension 22, the floating head slider 23 can be continuously floated with a comparatively high rigidity during rotation of the magnetic disk 15.

While the floating head slider 23 is floating, when the head actuator 17 rotates around the pivot 19, the floating head slider 23 can move along the radius line of the magnetic disk 15. As a result, the electromagnetic conversion element on the floating head slider 23 is capable of crossing the data zone between the recording track of the inner most circumference and the recording track of the outer most circumference. Accordingly, the electromagnetic conversion element on the floating head slider 23 can be located on the target recording track.

The actuator block 18 is coupled with a voice coil motor (VCM) 24. A supporting body 25 which extends in the horizontal direction from the pivot 19 is integrally formed with the actuator block 18. A coil 26 of the VCM 24 is wound around the supporting body 25. The supporting body 25 is provided facing a permanent magnet (not illustrated) fixed to the VCM 24. When the coil 26 generates a magnetic field in accordance with the supply of current, the actuator block 18, namely the head actuator 17, is driven to make the head actuator 17 and head slider 23 swing.

The HDD of the present invention employs the lump loading system. At the end part of the head suspension 22, a loading member, namely a fixed loading tab 27, extends forward from the end part of the head suspension 22. The loading tab 27 can be moved in the radial direction of the magnetic disk 15 on the basis of the swing of the head actuator 17. On the moving path of the loading tab 27, a lump member 28 is located beyond the outer circumferential side of the magnetic disk 15. The loading tab 27 is received by the surface of the lump member 28.

The lump member 28 is provided with a mounting board 29 which is threadedly secured by screws, for example, to the bottom plate of the base 13 at the external side of the magnetic disk 15. On the mounting board 29, a projected piece 31 projects along the horizontal plane toward the pivot 19 of the head actuator 17. The projected piece 31 can be integrated, for example, to the mounting board 29 on the basis of the integral molding method. The end part of the projected piece 31 opposes a non-data zone at the external side of the outer most circumferential recording track of the recording media 15.

The lump member 28 and loading tab 27 cooperate to form a so-called loading and unloading mechanism. The lump member 28 is desirably molded, for example, from hard plastic material.

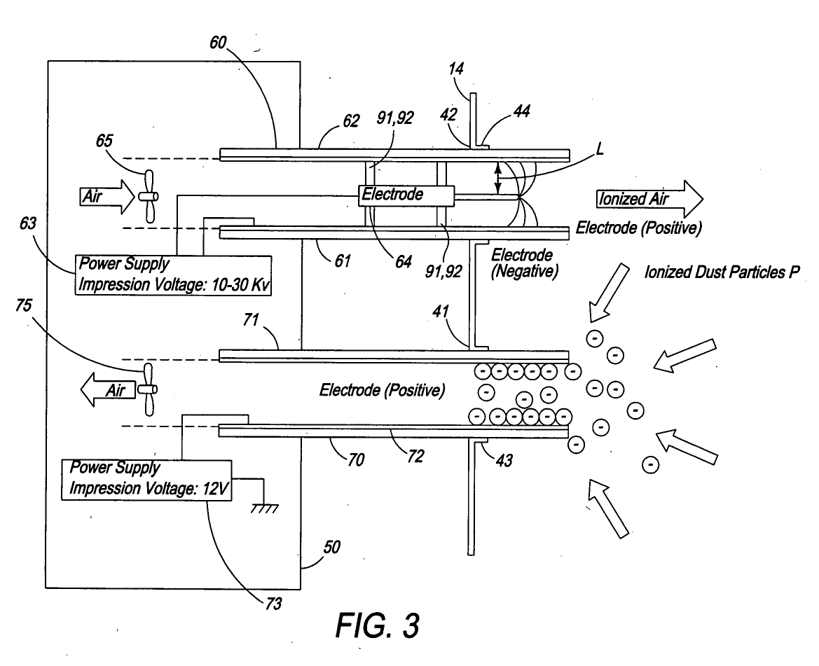

As explained above, the HDD is assembled with each component within the clean room, followed by closing of the base 13 and the cover 14, which are held together by threaded screws. Finally, a seal is attached to the cover and base to perfectly seal the space inside the HDD. Immediately before such perfect sealing, dust particles within the accommodation space can be removed with air cleaning apparatus 50 (FIG. 3).

FIG. 3 is a diagram schematically illustrating the internal structure of the air cleaning apparatus of the embodiment of the present invention.

The air cleaning apparatus 50 is provided with an air inflow nozzle 60 for taking in outside air, and an air exhaust nozzle 70 for exhausting the air to circulate the air between the air cleaning apparatus and the inside of the HDD. The air inflow nozzle 60 and the air exhaust nozzle 70 are respectively inserted into an air inflow port 42 and an air exhaust port 41 of the cover 14.

The external circumferences of the air inflow nozzle 60 and air exhaust nozzle 70 are constituted with insulating guide pipes formed of a material such as an insulating resin, for electrical insulation, being placed in close contact with the air inflow port 42 and the air exhaust port 41 with elasticity thereof.

The air inflow port 42 and the air exhaust port 41 are formed when the cover 14 is press-molded. As illustrated with a dotted line in FIG. 2, the air inflow port 42 and the air exhaust port 41 are desirably provided in the side of the cover at the opposing location within a space where a signal processing circuit (read/write channel) and a flexible circuit board (FPC) 30 are connected to a head circuit (head IC), namely in the space adjacent to the voice coil motor 24, so as to not damage the head and medium.

Moreover, components such as the head actuator and FPC 30 have complicated shapes, and dust particles adhered thereto are often left as they are. Accordingly, such dust particles become a cause of contamination inside the HDD. Therefore, it is better for effective dust collection, to perform dust collection at the area near the contamination source, and to provide the air inflow port 42 and the air exhaust port 41 near the FPC 30 and voice coil motor 24 of the head actuator. In this embodiment, the air inflow port 42 and the air exhaust port 41 are provided in the cover, but these may also be provided in the base side.

The air inflow port 42 is provided with an annular rib 44 to assure easier insertion of the air inflow nozzle 60, while the air exhaust port 41 is provided with an annular rib 43 to assure easier insertion of the air exhaust nozzle (dust collection nozzle) 70.

A cylindrical ionizing electrode 62 is provided within the insulating guide pipe 61 of the air inflow nozzle 60. Moreover, a needle type ionizing electrode 64 is internally provided at the center of the cylinder of the ionizing electrode 62. The ionizing electrodes 62, 64 are respectively connected to a power supply 63, and the ionizing electrode 62 functions as a negative electrode, while the ionizing electrode 64 acts as a positive electrode. For generation of corona discharge, the distance L between the surface of the ionizing electrode 62 and the end part of the needle of ionizing electrode 64 is set, for example, to about 1 to 3 mm.

A cylindrical positive electrode used as a dust collecting electrode 72 is provided in the insulating guide pipe 71 of the air exhaust nozzle 70. One end of the power supply 73 is connected to the dust collecting electrode 72, while the other end is connected to the ground. It is enough when the internal diameter of each nozzle is set, for example, to 3 to 10 mm.

The hole size of the air inflow port 42 and the air exhaust port 41 is preferably set to a small size in order to keep strength in the cover. Accordingly, it is better to set the internal diameter of each nozzle to a smaller size. In this embodiment, the internal diameter of each nozzle is set to about 3 mm, while the distance L between the end part of the ionizing electrode 62 and the surface of the ionizing electrode 64 is set to about 1 mm.

The electrodes 62, 72 are formed of a conductive material such as copper Cu and gold Au, and the ionizing electrode 64 may be formed of tungsten or the like. The needle type (needle discharge type) ionizing electrode 64 has been explained above, but this electrode may also be formed as a wire type (ionizing line system) or a plate type electrode. Moreover, the needle type and wire type ionizing electrodes 64, which can be inserted into a narrow nozzle, are preferable for effective discharge near the air inflow port 42 and effective supply of electrons into the apparatus.

A fan 65 may be internally provided within the air inflow nozzle 60, as illustrated in FIG. 3, but the fan 65 can be provided anywhere in the air flowing path connected to the air inflow nozzle 60. A fan 75 may be internally provided in the air exhaust nozzle 70, as illustrated in FIG. 3, but the fan 65 can be provided anywhere in the air flowing path connected to the air exhaust nozzle 70.

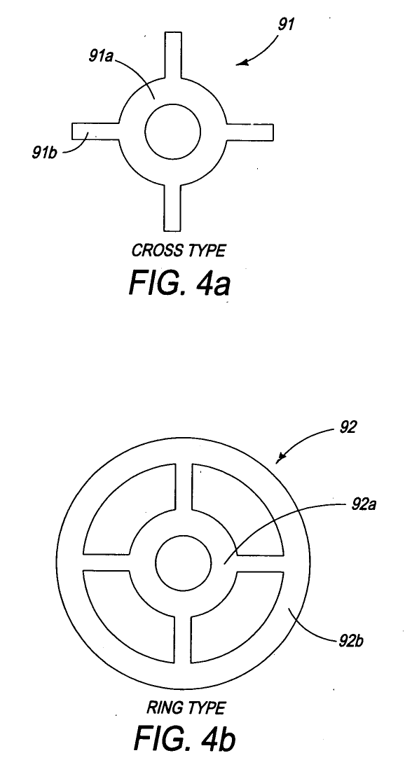

FIGS. 4(a) and 4(b) are diagrams illustrating an enlarged needle type ionizing electrode holding member. FIG. 4(a) is a cross type holding member 91 including a ring 91a to support the ionizing electrode 64 through insertion of the ionizing electrode 64 into a center hole. In this case, four cross-supporting members 91b are provided to hold the position of the ionizing electrode 64 within the nozzle.

FIG. 4(b) is a ring type holding member 92 including a ring 92a for supporting the ionizing electrode 64 through insertion of the ionizing electrode 64 into a center hole. In this case, a ring type supporting member 92b is provided to hold the position of the ionizing electrode 64 within the nozzle. The needle type ionizing electrode 64 can be stably positioned and supported within the nozzle by at least two holding members 91 and/or 92.

The holding member may be made of any suitable material, including a resin material such as Derlin, or other materials having sufficient insulation properties, and holding strength.

The air cleaning process sequence is as follows.

(1) The air inflow nozzle 60 is inserted into the air inflow port 42. Moreover, the air exhaust nozzle 70 is inserted into the air exhaust port 41.

(2) Next, the power supply 63 respectively impresses a voltage as high as about 10 to 30 kV, for example, to the ionizing electrodes, namely the negative electrode 62 and positive electrode 64.

(3) Since the positive electrode (dust collecting electrode) 72 is provided within the air exhaust nozzle 70, the power supply 73 impresses a voltage, for example, of 12V.

(4) For the air cleaning process, the head slider 23 is not loaded on the magnetic disk medium, but while the head assembly is latched with a latch mechanism, the magnetic disk medium 15 is rotated at a higher speed to generate convection of the air in the DE for stirring the air and to float dust particles.

(5) With step (2) explained above, the corona discharge is generated, thereby charging the floating particles. In more practical terms, a radially intensive electric field is generated by the corona discharge. The gas molecules near the discharging area (needle type positive electrode 64 and negative electrode 62) enter a plasma state, and a large number of electrons are generated. These electrons are then diffused into the air to ionize the molecules of air. As explained above, the charged negative-ion air (ionized air) is sent into the DE (HDD) by the fan 65 to charge the dust particles in the DE and generate the negative ions.

(6) The dust particles P (FIG. 3) of the negative ions are attracted to the positively charged dust collecting electrode 72 within the air exhaust nozzle 70 by the static electricity effect. Moreover, the dust particles P are also attracted by an attracting force of the fan 75. The dust particles P are finally collected in a filter (not illustrated) provided in the air cleaning apparatus 50. The air having completed dust collection may be returned to the DE through circulation or may be exhausted to the external side, i.e., the atmosphere.

The air cleaning process time can be set, for example, to 10 minutes. The air flows into the DE at a flow rate, for example, of about 10 to 100 cc/sec. In order to suppress ozone gas generated by the corona discharge, a gas such as oxygen gas may be used. The oxygen gas does not generate ozone and it can be expected to prevent corrosion of components within the DE by the ozone gas.

(7) After completion of the air cleaning process, each nozzle is removed respectively from the air inflow port 42 and the air exhaust port 41, and the air inflow port 42 and the air exhaust port 41 are covered with a hermetical seal 81 (FIG. 1).

Before the air cleaning process, it is better that the respective portions other than the air inflow port 42 and the air exhaust port 41 are covered with the hermetical seal in order to prevent entry of the air from outside of the apparatus. Namely, the threaded holes and gap between the cover and the base are closed with the other hermetical seals not illustrated.

When the present invention is applied to HDDs using the head loading/unloading system previously described, dust can be sufficiently removed with just the air cleaning process of the present invention before delivery of the apparatus. It is no longer required, unlike the HDD using the CSS system disclosed in patent document 1, to make the HDD large by integrating the air cleaning apparatus and mounting components unrelated to ordinary operations (read/write operations) of the air cleaning process.

Thereafter, the air cleaning apparatus of the present invention is finally delivered from the manufacturing factory after various tests and servo track write processes. The DE after delivery from the factory is kept under the hermetical sealed condition, but it is also possible to conduct the air cleaning process, if necessary, at the time of maintenance work for repair purposes.

The static electricity type air cleaning apparatus of the present embodiment is capable of more reliably removing fine particles of dust which are imported in the manufacturing processes than the ordinary air cleaning apparatus. Moreover, the nano-level dust particles which are too small to be captured with other filtering systems can also effectively and reliably be removed. Accordingly, a fault generating rate for faults such as damage of the head and magnetic disk medium can be lowered remarkably by preventing the influence of dust particles on the head slider, the magnetic disk medium of the head slider, and the head element.

Moreover, improvement in the dust removal rate can improve the useful life of absorbing agents and drying agents used in the DE.

In this embodiment the corona discharge system has been described, but electrons may be generated in the gas in other ways and thereby the ionized air may be generated with other gas discharge systems.

In this embodiment, a hermetically closed type magnetic disk apparatus using a magnetic disk and a magnetic head slider has been explained, but the present invention can also be applied to other storage medium drives having a hermetically closed structure such as an optical magnetic disk apparatus using an optical magnetic disk and magnetic head slider, and an optical disk apparatus using an optical disk and optical head slider.

According to the present invention, as explained above, it is possible to provide an air cleaning method and an air cleaning apparatus for highly reliable storage medium drives which can effectively collect and remove nano-level dust particles within the storage medium drive, and can also reduce the fault generating rate of the storage medium drives.

What is claimed is:

1. An air cleaning method for a storage medium drive, the storage medium drive having a housing, an air inflow port and an air exhaust port, comprising the steps of:
(a) inserting an air inflow nozzle for taking air into said storage medium drive through the air inflow port, the air inflow nozzle having an internal ionization electrode for ionizing dust particles within the storage medium drive;
(b) inserting an air exhaust nozzle for flowing the air out of the storage medium drive through the air exhaust port, said air exhaust nozzle having an internal dust collecting electrode for collecting the ionized dust particles within the storage medium drive;
(c) electrifying the dust particles within the storage medium drive by supplying a voltage to said ionizing electrode;
(d) collecting the dust particles by attracting the dust particles to said dust collecting electrode;
(e) exhausting the collected dust particles to outside of the storage medium drive by using said air exhaust nozzle;
(e) removing said air inflow nozzle and said air exhaust nozzle after completion of dust collection; and
(f) sealing the air inflow port and the air exhaust port.

2. The air cleaning method according to claim 1, wherein the air is oxygen gas.

3. An air cleaning apparatus for a storage medium drive comprising at least:
an air inflow nozzle taking air into said storage medium drive, said air inflow nozzle being internally provided with an ionizing electrode for ionizing dust particles within said storage medium drive; and
an air exhaust nozzle for flowing the air to outside of said storage medium drive, said air exhaust nozzle being internally provided with a dust-collecting electrode for collecting the electrified dust particles taken from within said storage medium drive.

4. The apparatus of claim 3, wherein the air inflow nozzle includes a first insulating guide pipe.

5. The apparatus of claim 4, wherein said first insulating guide pipe is made of an insulating resin.

6. The apparatus of claim 3, wherein said air exhaust nozzle includes a second insulating guide pipe.

7. The apparatus of claim 6, wherein said second insulating guide pipe is made of an insulating resin.

8. The apparatus of claim 3, comprising:
a cylindrical ionizing electrode within said first insulating guide pipe of the air inflow nozzle.

9. The apparatus of claim 8, wherein the cylindrical ionizing electrode functions as a negative electrode.

10. The apparatus of claim 8, wherein a needle-type ionizing electrode is internally provided at the center of said cylindrical ionizing electrode.

11. The apparatus of claim 10, wherein the distance between the surface of said cylindrical ionizing electrode and an end part of said needle-type ionizing electrode is set so as to generate a corona discharge when a sufficient voltage is applied between said electrodes.

12. The apparatus of claim 11, wherein the distance between the surface of said cylindrical ionizing electrode and the end part of said needle-type ionizing electrode is between about 1 and 3 millimeters.

13. The apparatus of claim 12, wherein the internal diameter of said air inflow nozzle and said air exhaust nozzle is about 3 to 10 millimeters.

14. The apparatus of claim 13, wherein the internal diameter of said air inflow nozzle and said air exhaust nozzle is about 3 millimeters, and the distance between said needle-type ionizing electrode and the surface of said cylindrical ionizing electrode is about 1 millimeter.

15. The apparatus of claim 3, comprising:
a first cylindrical ionizing electrode within said air inflow nozzle;
a second cylindrical ionizing electrode within said air exhaust nozzle; and
a needle-type ionizing electrode internally provided at the center of said first cylindrical ionizing electrode;
wherein said first and second cylindrical ionizing electrodes are formed of a conductive material such as copper or gold, and said needle-type ionizing electrode is formed of tungsten or the like.

16. The apparatus of claim 3, comprising a fan internally provided within said air inflow nozzle.

17. The apparatus of claim 3, wherein said ionizing electrode includes a needle-type ionizing electrode, and said needle-type ionizing electrode is supported by a cross-type holding member having a ring to support said needle-type ionizing electrode through insertion of said needle-type ionizing electrode into a center hole within said ring, said cross-type holding member further having four cross-supporting members provided to hold the position of said needle-type ionizing electrode within said air inflow nozzle.

18. The apparatus of claim 17, wherein said cross-type holding member is made of a resin material.

19. The apparatus of claim 3, wherein said ionizing electrode includes a needle-type ionizing electrode, and said needle-type ionizing electrode is supported by a ring-type holding member including an inner ring for supporting said needle-type ionizing electrode through insertion of said ionizing electrode into a center hole, said holding member having an outer ring provided to hold the position of said needle-type ionizing electrode within said air inflow nozzle, said inner ring being stably positioned and supported within said outer ring by at least two connecting members.

20. The apparatus of claim 19, wherein said ring-type holding member is made of a resin material.
